(19) United States
(12) Patent Application Publication
(10) Pub. No.: US 2006/0102481 A1
(43) Pub. Date: May 18, 2006

(54) Open frame gel casting in submarine gel electrophoresis

(76) Inventor: Stephen L. Chen, Portland, OR (US)

Correspondence Address: Stephen L. Chen, 21109 NW Galice Ln, Portland, OR, 97229, US

(21) Appl. No.: 10/989,769

(22) Filed: Nov. 16, 2004

(51) Int. Cl. B01D 57/02; G01N 27/447

(52) U.S. Cl. 204/470; 204/616

(57) ABSTRACT

A device and method enables rapid gel casting and two-dimensional electrophoresis of a gel matrix. Agarose gel liquid is poured directly onto a flat metal surface for rapid instant formation of gel matrix. An open frame without bottom plastic anchors the gel matrix for easy handling. Electric pathways are reserved to 4 sides of the gel matrix, which permits the gel matrix being used in 2 orientations.

### FIELD OF THE INVENTION

The present invention relates in general to devices and methods of gel electrophoresis, and in particular, to devices and methods of gel casting in submarine gel electrophoresis.

### BACKGROUND OF THE INVENTION

Gel electrophoresis is one of the most frequently utilized tools for biomedical researches and industries. In gel electrophoresis, samples are loaded into a plurality of sample wells of a gel matrix. Charged molecules in loaded samples migrate from sample wells into gel matrix when electric field being applied. Different molecules migrate in different rates and appear as distinguishable bands in gel matrix. By placement of gel matrix, gel devices and methods have been classified into horizontal gel electrophoresis and vertical gel electrophoresis. Submarine gel electrophoresis is one of the most popular formats of horizontal gel electrophoresis. In which gel matrix is completely immersed under running buffer.

Agarose is the most popular gelling chemical utilized in submarine gel electrophoresis. In gel casting, the first step is to boil gel solution for dissolving agarose powder. Then the hot agarose gel liquid cools down slowly and solidifies as gel matrix.

As a liquid, hot agarose gel solution flows randomly. To control gel dimension, a variety of gel trays and gel casting stands has been used to establish a sealed enclosure for holding the gel liquid. A typical gel tray is made with plastics in “U” shape having a flat bottom and 2 longitudinal sidewalls. Two open ends of the gel tray are reserved as electric pathways of gel matrix to electrodes of a submarine gel apparatus. During gel casting, the two open ends are sealed by tape or casting stand. Gel liquid leakage is sometimes a problem when the sealing fails. To overcome leaking problem, Hsu, in U.S. Pat. No. 6,576,109, teaches a leaking free device for gel casting using a gel tray, stop members, and stop plates.

In applications, gel electrophoresis projects vary from time to time. For a PCR sample screening experiment, for example, a gel tray with extra wide width and short length is desired. In genome project, a gel tray with extra long length is essential. To meet such diversified needs, many sets of gel electrophoresis systems will be accumulated in laboratories. One set for one purpose only.

After decades with the tradition of using gel tray in submarine gel electrophoresis, some basic questions are forgotten:

Why gel trays are used in only one orientation?

Why gel trays have to be sealed for gel casting?

Why wasting time in slow cooling down of gel liquid?

These basic questions lead to the creation of open frame gel casting, a unique concept and strategy different from current understanding of gel casting.

Frame is a simple rectangular structure existing in our daily life, such as picture frames on the wall. In submarine gel electrophoresis field, White et al, in U.S. Pat. No. 6,106,686, teaches a frame to seat over a precast gel matrix during electrophoresis process to prevent gel slab from floating. White et al limits, unfortunately, his frame within electrophoresis process only and fails to discover novel function of a frame for gel casting. White et al emphasizes in claims that his frame support member should seat on top of the gel slab without penetrating or lacerating the gel slab. White et al also fails to explain how to manufacture his precast gel. White et al further fails to teach his gel slab for 2-orientation electrophoresis.

In brief, current understanding of gel casting is limited within the concept of using gel trays and sealing means for submarine gel electrophoresis.

### SUMMARY OF THE INVENTION

It is, therefore, an object of the invention to introduce a simple concept and strategy for generating novel device and method of gel casting in submarine gel electrophoresis. The advantages of the device and method are:

(1) It works faster. Hot agarose gel liquid solidifies instantly on metal plate.

(2) It gains flexibility. One casting device used to form either a portrait gel or a landscape gel.

(3) It simplifies gel casting device and operation.

### BRIEF DESCRIPTION OF THE DRAWINGS

FIG. 1 is a perspective view of an embodiment of the invention.

FIG. 2 is a cross sectional view of an enlarged diagram illustrating an anchoring structure of the embodiment during gel casting.

FIG. 3 is a perspective view of a gel matrix being hooked onto the embodiment.

FIG. 4 is a cross sectional view of a submarine gel apparatus using the embodiment.

### DETAILED DESCRIPTION OF THE INVENTION

In general life when water spills on a flat clean glass, we can see water drops in random and irregular shape. The thickness of water drops is usually about 4-5 mm retained by action of liquid surface tension. In submarine gel casting, the thickness of gel matrix is also about 4-5 mm. This similarity comparison implies that liquid surface tension could be utilized for gel casting in submarine gel electrophoresis.

However, random water spill method is not acceptable for gel casting because gel matrix with certain dimension is required. After testing, it is found that a simple open frame over the flat glass will satisfy the dimension requirement. The open frame is simply placed on the glass. Gaps between the open frame and glass should allow the spilt water to flow away from the open frame. In fact, spilt water stays within the open frame even though gaps are not sealed. A capillary attraction force is generated onto the spilt water by the open frame. This force traps spilt water from flowing away. It indicates that a gel matrix can be formed in such a simply way without using gel trays and sealing means.

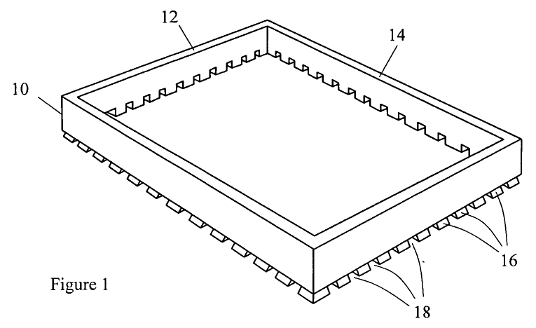

FIG. 1 shows a perspective view of open frame 10 for gel casting. Open frame 10 has only 4 side arms similar to a picture frame in rectangular shape. The length of short arms 12 and long arms 13 are determined by application desires. Popular gel sizes are, for example, 12 cm×8 cm and 10 cm×6 cm. A plurality of anchor structure 16 is extended from bottom edge of 4 side arms. Gaps 18 are reserved as open spaces between neighbor units of anchoring structure 16.

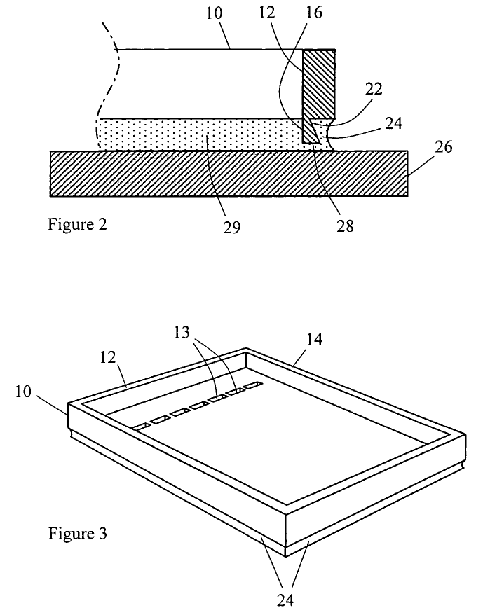

Anchoring structure 16, an essential element, is illustrated in FIG. 2 enlarged diagram. Each unit of anchoring structure 16 has a big base 28 and narrow neck 22. For general applications, each unit is built with a length 6 mm and a height 5 mm. Its width reduces from 3 mm at base 28 to 1.5 mm at neck 22, which makes base 28 bigger than neck 22.

To cast a gel, open frame 10 is first placed on a flat surface 26 with anchoring structure 16 pointing to flat surface 26. Gel liquid 29 in a certain volume is then poured into open frame 10 to immerse all anchoring structure 16. After solidification, gel liquid 29 becomes gel matrix 24. Gel matrix 24 is hooked onto open frame 10 along its perimeter. The joint is secured from accidental detachment because base 28 is bigger than neck 22. Now gel matrix 24 can be handled in the way similar to a conventional gel in a gel tray, even though there is no bottom plastic sheet to support gel matrix 24, as shown in FIG. 3. To further enhance the strength of joining force, more units of anchoring structure 16 can be installed. Base 28 in different shape can also provide extra hooking power. In general, enough hooking strength can be obtained by installing 1 unit of anchoring structure 16 in every 1 cm distance along side arms of open frame 10.

Flat surface 26 provides support to open frame 10 and receive gel liquid 29 during gel casting. After gel casting, flat surface 26 form the bottom face of gel matrix 24. When starting electrophoresis, open frame 10, together with hooked gel matrix 24, is separated from flat surface 26 and placed in submarine gel apparatus 42. That is, flat surface 26 has no function during electrophoresis, which enables the first improvement of the invention: Rapid gel casting.

In conventional gel casting, gel tray bottom has to be electric insulated, usually plastics, because it is used for both gel casting and electrophoresis in electric field. A plastic has poor property of thermal transfer. In contrast, flat surface 26 is used only for gel casting. A metal plate can be used to replace plastics. In the embodiment, flat surface 26 is an aluminum plate, a potent heat sink, in a size 30 cm×20 cm×1 cm. Hot agarose gel liquid is poured onto the metal plate in direct contact. Heat transfers instantly from gel liquid 29 to flat surface 26. The waiting time of gel cooling is dramatically reduced.

A functional requirement to gel matrix 24 is its electric pathway in electrophoresis via buffer solution. A conventional gel in gel tray can only be used in one orientation because two longitudinal sidewalls of gel tray insulate its electric pathways. Open frame 10 provides electric pathways to every edges of gel matrix 24 via gaps 18 and open spaces between base 28 and bottom of submarine gel apparatus 42. Because gel matrix 24 has no plastic sheet underneath, its bottom face is open and immersed in buffer 40 when placed to submarine gel apparatus 42.

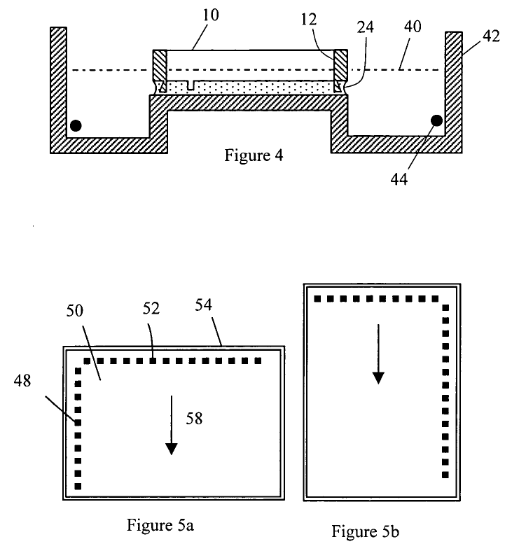

During gel casting, gel liquid 29 flows across gaps 18 to form exposed edge of gel matrix 24, as shown in FIG. 3. Edges of gel matrix 24 will contact buffer 40 directly in submarine gel apparatus 42, as shown in FIG. 4. This structure makes the second improvement feasible: Two-dimensional electrophoresis.

To cast a long length gel for genome project, a plurality of sample wells 13 is formed in parallel with short arms 12, as shown in FIG. 3. To cast a wide and short gel for PCR project, sample wells 13 can be formed in another orientation, in parallel with long arm 14. The entire open top of open frame 10 allows free access of well forming combs into gel liquid 29 in both orientations. After gel casting, open frame 10 with gel matrix 24 is placed in submarine gel apparatus 42 in a proper orientation for electrophoresis. To fit inside submarine gel apparatus 42 for both orientations, the length of long arm 14 of open frame 10 should be equal or smaller than the internal size of buffer tank of submarine gel apparatus 42.

The capacity of two-dimensional electrophoresis is meaningful for precast gels. FIG. 5a shows a frame member 54 holding a precast gel 50. Two rows of sample wells, 48 and 52 in perpendicular angle, are formed along two edges of precast gel 50. Users have the freedom to use precast gel 50 in either a landscape gel format or a portrait gel format, as shown in FIGS. 5a and 5b respectively. Arrow 58 indicates sample migration direction in electrophoresis.

Although the description above contains specifications, it will apparent to who's skilled in the art that a number of other variations and modifications may be made in this invention without departing from its spirit and scope. Open frame 10, for example, can be altered in numerous ways using plastic molding method. Flat surface 26 can be replaced by bench top to support open frame 10 for gel casting. Gel liquid 29 can be replaced by acrylamide gel solution. Anchoring structure 16 can be omitted when open frame 10 is used to generate hooking force. Thus, the description as set out above should not be constructed as limiting the scope of the invention but as merely providing illustration of the presently preferred embodiment of the invention.

What is claimed is:

1. A device for casting a gel liquid to form a gel matrix used in a submarine gel apparatus, comprising:
a frame in substantially rectangular shape with a size fitting inside said submarine gel apparatus, having a bottom defining an area for said gel liquid, having an open top allowing access of well forming combs to said gel liquid, and having side members surrounding perimeter of said gel matrix for easy handling;
a flat surface in a size equal to or greater than the size of said frame, positioned under said frame, contacting said gel liquid directly, forming bottom face of said gel matrix; and
anchoring structure, extending from said side members, intruding into said gel liquid, generating joining force between said frame and said gel matrix after solidification of said gel liquid, hooking said gel matrix onto said frame for easy transportation, and reserving gaps for electric communication of said gel matrix from any orientation of said frame to said submarine gel apparatus.

2. A device for casting a gel liquid to form a gel matrix as claimed in claim 1 wherein said flat surface is a metal plate in a size of 30 cm×20 cm×1 cm.

3. A method for casting a gel liquid to form a gel matrix used in a submarine gel apparatus, comprising:
a. having a device comprising:
a frame in substantially rectangular shape with a size fitting inside said submarine gel apparatus, having a bottom defining an area for said gel liquid, having an open top allowing access of well forming combs to said gel liquid, and having side members surrounding edges of said gel matrix for easy handling;
a flat surface in a size equal to or greater than the size of said frame, positioned under said frame, contacting said gel liquid directly, forming bottom face of said gel matrix; and
anchoring structure, extending from said side members, intruding into said gel liquid, generating joining force between said frame and said gel matrix after solidification of said gel liquid, hooking said gel matrix onto said frame for easy transportation, and reserving gaps for electric communication of said gel matrix from any orientations of said frame to said submarine gel apparatus.
b. placing said frame onto said flat surface with said anchoring structure pointing to said flat surface;
c. introducing said gel liquid and said well forming combs into said frame to form said gel matrix;
d. separating said frame with hooked said gel matrix from said flat surface; and
e. placing said frame with hooked said gel matrix into said submarine gel apparatus for electrophoresis.

4. A method for casting a gel liquid to form a gel matrix as claimed in claim 3 wherein said bottom face of said gel matrix contacts running buffer directly in said submarine gel apparatus.
